(19) United States
(12) Patent Application Publication
(10) Pub. No.: US 2002/0187829 A1
(43) Pub. Date: Dec. 12, 2002

(54) Cooperation service method of contents viewing/listening and an attraction, and contents receiver and attraction system which are used for this method

(76) Inventor: Takashi Hasegawa, Hachioji (JP)

Correspondence Address: MATTINGLY, STANGER & MALUR, P.C, ATTORNEYS AT LAW, SUITE 370, 1800 DIAGONAL ROAD, ALEXANDRIA, VA, 22314, US

(21) Appl. No.: 09/941,751

(22) Filed: Aug. 30, 2001

(30) Foreign Application Priority Data
Jun. 7, 2001 (JP) 2001-171973

(51) Int. Cl. A63F 9/24; A63F 13/00

(52) U.S. Cl. 463/29

(57) ABSTRACT

Viewing-and-listening information on viewing-and-listening of contents relating to an attraction is recorded in a portable recording medium, the viewing-and-listening information recorded in the recording medium is read in an attraction system for performing the attraction, and a privilege service is carried out based on the read viewing-and-listening information. Consequently, it is possible to produce the effect of inviting the contents viewer-and-listener to the theme park.

### BACKGROUND OF THE INVENTION

The present invention relates to a cooperation service method of contents (images or sounds) viewing/listening and an attraction, in which the contents viewing-and-listening cooperates with the service of an attraction in a theme park or the like.

In recent years also in Japan, there have appeared various kinds of theme parks, in which there have been prepared so popular attractions for which people queue up (for example, space adventure simulations or large-scaled corkscrews). People are amused by getting on a vehicle (hereinafter referred to as “a ride”) in many of the attractions. At this time, a visitor can have the privilege of having his or her name called by a character (for example, a hero or a heroine of the attraction) at the end of the attraction. A visitor who wants to receive such a service previously registers his or her name before getting on the ride.

In the meantime, among contents (images or sounds) to be broadcast over a television broadcasting network, a transmission path of the Internet or the like or contents to be supplied through a medium such as a DVD (a digital versatile disk), some of popular programs may include contents relating to the above-described attraction. To the contrary, broadcast or supplied contents (for example, an animation picture which handles dinosaurs) may grow in popularity to thus constitute the material of an attraction.

### SUMMARY OF THE INVENTION

The name calling in the attraction was a service for a visitor who has already visited the theme park, but it could not produce any effect of inviting, to the theme park, a visitor existing outside of the theme park. Otherwise, even if the visitor viewed and listened to the contents relating to the attraction, there was no service of connecting the contents viewing-and-listening to a visit to the theme park.

An object of the present invention is to provide a cooperation service method of contents viewing/listening and an attraction, and a contents receiver and an attraction system which are used for the service, which can produce the effect of inviting a contents viewer-and-listener to a theme park.

In order to achieve the above-described object, a cooperation service method of contents viewing/listening and an attraction according to the present invention, viewing-and-listening information on viewing-and-listening of contents relating to an attraction is recorded in a portable recording medium (hereinafter referred to as “a removable media”), the viewing-and-listening information recorded in the removable media is read in an attraction system for performing the attraction, and a privilege service of the attraction is carried out based on the read viewing-and-listening information.

The viewing-and-listening information includes at least either one of a viewing-and-listening history, in which the contents viewing-and-listening is recorded, and privilege information on the privilege service relating to the contents. In many cases, the viewing-and-listening information includes personal information on a contents viewer-and-listener.

The cooperation of the contents viewing/listening and the attraction is established via the removable media by offering the privilege service to the contents viewer-and-listener in the attraction, thus producing the effect of inviting the contents viewer-and-listener to the theme park.

### BRIEF DESCRIPTION OF THE DRAWINGS

FIG. 1 is a view illustrating the basic configuration of a cooperation service method of contents viewing/listening and an attraction in a preferred embodiment according to the present invention;

FIG. 2 is a flowchart illustrating the cooperation service method of contents viewing/listening and an attraction in the preferred embodiment according to the present invention;

FIG. 3 is a block diagram illustrating a contents receiver in the preferred embodiment according to the present invention;

FIG. 4 is a diagram illustrating an example of personal information;

FIG. 5 is a diagram illustrating information on contents to be broadcast;

FIG. 6 is a diagram illustrating an example of privilege information and a viewing-and-listening history;

FIG. 7 is a flowchart illustrating an example of viewing-and-listening information recording processing;

FIG. 8 is a diagram illustrating the configuration of an attraction system in a preferred embodiment according to the present invention;

FIG. 9 is a flowchart illustrating an example of a privilege service in an attraction;

FIG. 10A illustrates an example of a template of a sentence; and

FIG. 10B is a flowchart illustrating an example of sentence composing processing in the privilege service.

### DETAILED DESCRIPTION OF THE PREFERRED EMBODIMENT

A cooperation service method of contents viewing/listening and an attraction, and a receiver and an attraction system which are used for the service according to the present invention will be described below in more details by way of a preferred embodiment illustrated in several sheets of drawings.

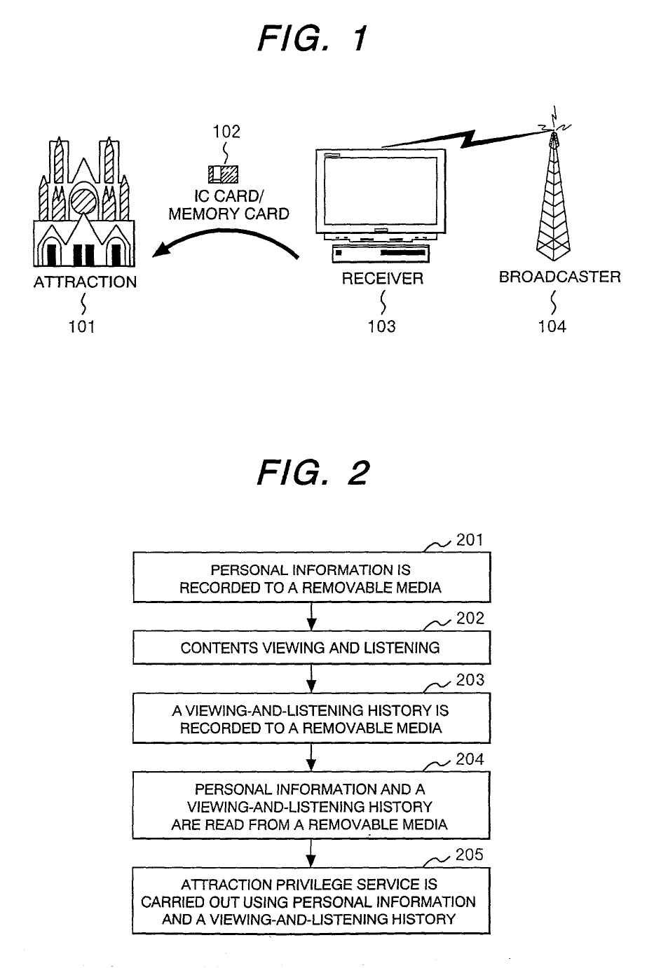

First, explanation will be made on the entire configuration for carrying out the present embodiment in reference to FIG. 1. The entire configuration comprises a broadcaster 104 for broadcasting contents such as images or sounds; a contents receiver 103 for receiving the contents so as to allow a user to view and listen to them and recording viewing-and-listening information required for receiving a privilege service in an attraction in a portable removable media 102 such as an IC card or a memory card; the removable media 102 storing the viewing-and-listening information therein; and an attraction system 101 for carrying out the privilege service based on the viewing-and-listening information recorded in the removable media in addition to a normal service.

Although the contents are broadcast from the broadcaster 104 through a transmission path by radio waves in FIG. 1, the contents may be broadcast through a transmission path over a broadband network such as the Internet, or may be supplied via a medium such as a DVD. Moreover, although a body for managing a viewer-and-listener or charging the viewer-and-listener for the contents viewing-and-listening is provided in the broadcaster 104, a department other than the broadcaster 104 may perform such managing or charging.

Next, the outline of the service in the present embodiment will be explained in reference to FIGS. 1 and 2. First of all, at the time of a contents viewing-and-listening contract or at the beginning of viewing-and-listening, personal information on a viewer-and-listener is recorded in the removable media 102 (step 201). Examples of a method for recording the information will be listed below:

a. A viewer-and-listener inputs his or her personal information by the use of the receiver 103, which then records the input personal information in the removable media 102;

b. The removable media 102 has been previously attached to the receiver 103. A viewer-and-listener mails a postcard, in which his or her personal information and information such as an identifier (ID) specifying a receiver are filled out, to the broadcaster at the time of an initial contract. Then, the broadcaster 104 broadcasts the personal information together with a receiver ID. The receiver 103 collates the receiver ID upon receipt of the information. In the case of matching of the receiver ID, the personal information is recorded in the removable media 102; and

c. A viewer-and-listener mails a postcard, in which his or her personal information is filled out, to the broadcaster at the time of an initial contract, and then, the broadcaster sends, to the viewer-and-listener, the removable media 102 in which the personal information is recorded.

Subsequently, when the viewer-and-listener views and listens to specified contents by using the receiver 103 (step 202), the receiver 103 records its viewing-and-listening history and privilege information in the removable media 102 (step 203). And then, when the viewer-and-listener brings the removable media 102 to a site in which the attraction system 101 is installed, the attraction system 101 reads viewing-and-listening information consisting of the personal information, the viewing-and-listening history and the privilege information (step 204), and thus, carries out the privilege service of an attraction based on the read viewing-and-listening information (step 205).

In the above-described manner, the viewer-and-listener can receive the privilege service, which is special for him or her and is never offered to other visitors, in the attraction as a result of the contents viewing-and-listening. Examples of such a privilege service include a service in which the attraction system 101 is operated in a manner different from a regular manner. Some of the privilege services in the attraction may not require any personal information, but may use only at least either one of the viewing-and-listening history and the privilege information.

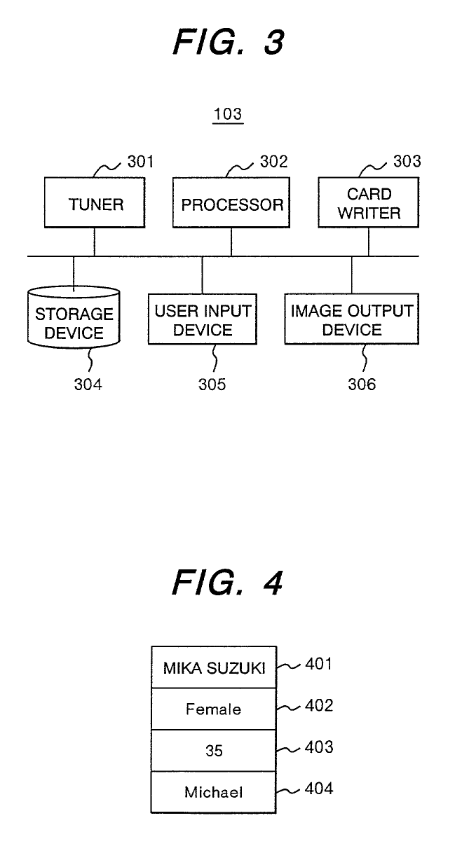

Here, FIG. 3 illustrates an example of the configuration of the contents receiver 103 used in the present embodiment. The receiver 103 comprises: a receiving device (a tuner) 301 for receiving the contents broadcast from the broadcaster 104 by the radio waves; a processor 302 for controlling the processing of recording the viewing-and-listening information in the removable media 102; a card writer (a recorder) 303 for recording the viewing-and-listening information in the removable media 102; a storage device 304 for storing therein the received contents, processing programs to be executed by the processor and the like; a user input device 305 such as a remote controller or a keyboard-and-mouse for selecting the contents to be viewed and listened to or inputting the personal information by the user; an image output device 306 such as a television for displaying the contents or various kinds of information to be viewed and listened to. Incidentally, in the case where data is broadcast from the broadcaster 104 over the broadband network, the tuner 301 is a network interface for the broadband network. Furthermore, in the case where the contents are supplied from the DVD, the tuner 301 is a DVD player.

Next, explanation will be made on an example of the personal information to be recorded in the removable media 102 by the card writer 303 in the contents receiver 103 in reference to FIG. 4. The personal information consists of the name 401, sex 402, age 403 and favorite character 404 of the viewer-and-listener. Here, FIG. 4 illustrates only the personal information read by the attraction system 101 in step 204 of the service in the present embodiment. Other viewing-and-listening contract information or the like may be actually recorded in the removable media 102. Moreover, a plurality of pieces of information on all members of a family or the like may be recorded in one piece of removable media 102.

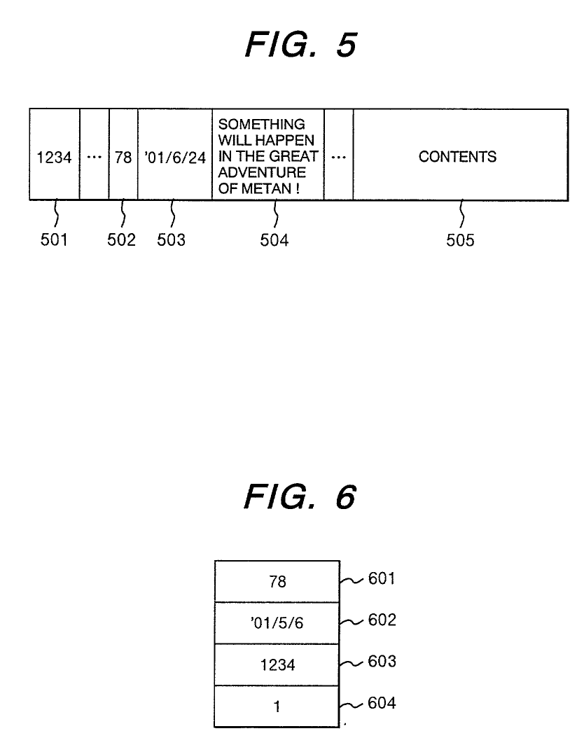

Subsequently, an example of information to be broadcast from the broadcaster 104 will be explained in reference to FIG. 5. The information to be broadcast includes contents 505, and a contents ID 501 specifying the contents, a service ID 502 indicating the kind of privilege in the attraction (none in the case of 0), an expiration date 503 of the privilege and a privilege message 504, each of which is information provided for the contents. Here, FIG. 5 illustrates only the information relating to the service in the present embodiment. Other viewing-and-listening contract information or the like may be actually broadcast. Furthermore, a plurality of sets, each of which consists of privilege information 502 to 504, may be broadcast with respect to a single set of contents 505. Moreover, the contents 505 and the information 502 to 504 relating to the service may be broadcast separately from each other (for example, by data broadcasting). In this case, the contents ID 501 and the information 502 to 504 relating to the service are broadcast, and then, the contents ID 501 is independently broadcast together with the contents 505, and thus, the same processing is performed by collating the contents ID 501 at the time of viewing and listening as in the case where the information is broadcast as illustrated in FIG. 5.

Next, explanation will be made on an example of the privilege information and viewing-and-listening history to be recorded in the removable media 102 by the card writer 303 in the contents receiver 103 in reference to FIG. 6. The privilege information includes a privilege service ID 601 and a service expiration date 602; and the viewing-and-listening history includes a viewed-and-listened contents ID 603 and the number 604 of times of viewing and listening. Here, FIG. 6 illustrates only the information relating to the service in the present embodiment. Other viewing-and-listening contract information or the like may be actually recorded. Furthermore, a plurality of sets, each of which consists of the contents related information 603 and 604, may be recorded in one service ID.

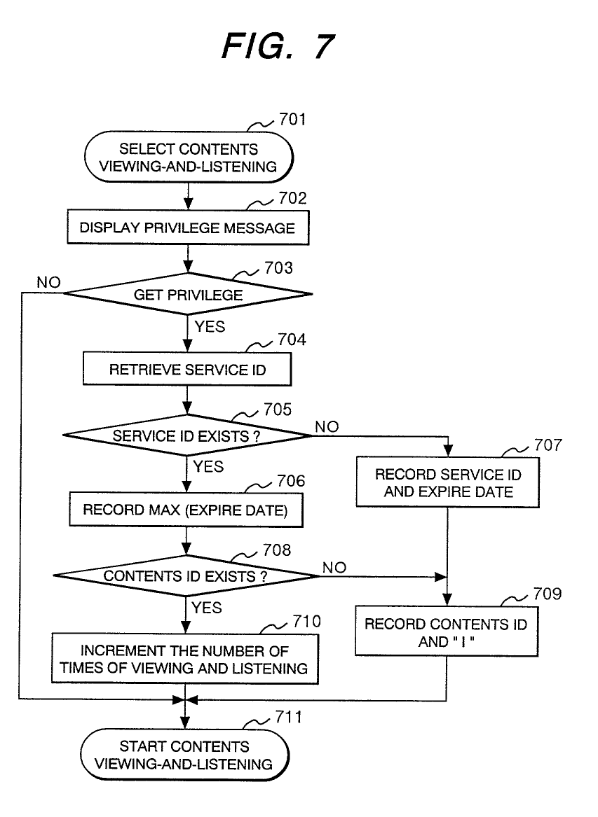

Next, the details of the viewing-and-listening information recording processing in step 203 will be explained in reference to FIGS. 7, 1 and 3 to 6. When the viewer-and-listener first selects viewing-and-listening of the contents 505 by the use of the receiver 103 (step 701), the message 504 indicating the privilege contents broadcast together with the contents is displayed on the receiver in the case where there is a privilege in the contents (step 702).

Subsequently, when the viewer-and-listener reads the message and selects to get the privilege (step 703), the ID 502 of the privilege is retrieved from the removable media 102 (step 704). Unless the viewer-and-listener selects to get the privilege, the contents viewing-and-listening is started (step 711).

As a result of the retrieval of the service ID, if the same ID 601 as the ID 502 is retrieved from the removable media 102 (step 705), a later one out of the corresponding expiration dates 503 and 602 is recorded in the removable media 102 (step 706). In the example illustrated in FIGS. 5 and 6, the broadcast expiration date, i.e., Jun. 24, 2001 is later, and therefore, the expiration date 602 to be recorded is changed from May 6, 2001 to Jun. 24, 2001.

Unless the service ID 502 is retrieved (step 705), the service ID 502 and the expiration date 503 are recorded again (step 707). If no service ID is retrieved (steps 705 and 707), or if no related contents ID 603 is retrieved (step 708) although the broadcast service ID 502 is retrieved from the removable media 102 (steps 705 and 706), the contents ID 501 and the number of times of viewing and listening being “1” are recorded in the removable media 102 (step 709).

If the contents ID has existed already (step 708), the number 604 of times of viewing and listening corresponding to the retrieved ID 603 is incremented by 1 (step 710). For example, in the case where the information illustrated in FIG. 6 has been already recorded and the viewer-and-listener views and listens to the contents 505 and selects to get the privilege, the number 604 of times of viewing and listening is 2. Upon completion of the above-described processing, the contents viewing-and-listening is started (step 711). Here, the number of times of viewing and listening may be recorded at the end of the contents viewing-and-listening.

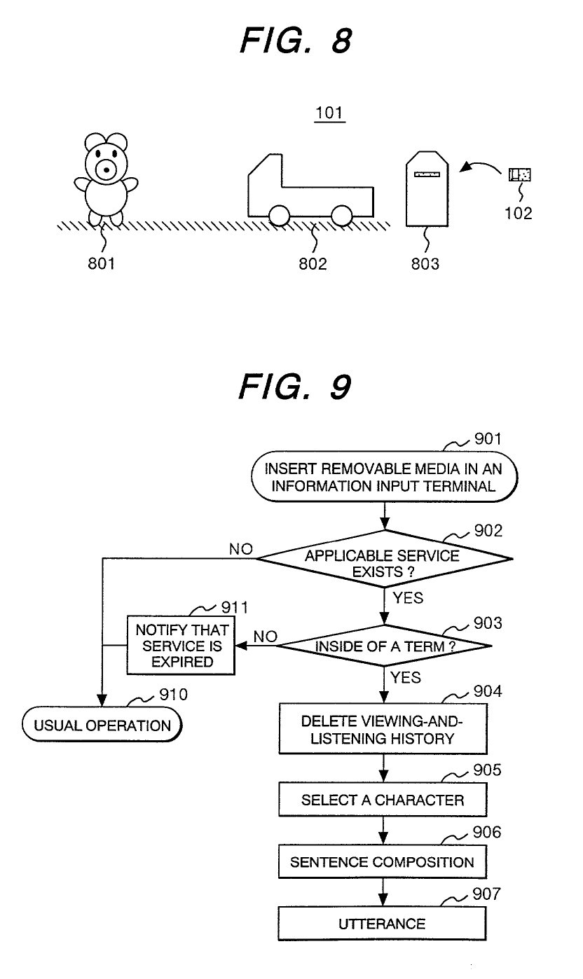

Next, the outline of an example of the configuration of the attraction system 101 will be explained in reference to FIG. 8. The attraction system 101 comprises an information input terminal (information input equipment) 803 installed at the entrance, for inputting the viewing-and-listening information recorded in the removable media 102, a ride 802, which the viewer-and-listener rides, and an attraction device 801 for carrying out an attraction. The attraction device 801 performs a privilege service based on the viewing-and-listening information input by the information input terminal 803.

The viewer-and-listener first inserts the removable media 102 into the information input terminal 803. And then, when the viewer-and-listener enters an attraction site on the ride 802, a character of the attraction device 801 talks to the viewer-and-listener. Here, the information input terminal 803, into which the removable media 102 is inserted, may be mounted on the ride 802. An IC card reader serves as the information input terminal 803 in the case where the removable media 102 is an IC card; and a memory card reader serves as the information input terminal 803 in the case where the removable media 102 is an memory card.

Next, the details of the attraction privilege service processing (step 205) will be explained in reference to FIGS. 8, 9, 1, 4 and 6. First, the viewer-and-listener brings the removable media 102 when he or she goes to a theme park. When the viewer-and-listener inserts the removable media 102 into the information input terminal 803 installed at the entrance of the attraction system 101 or into the information input terminal 803 mounted on the ride 802 (step 901), the personal information 401 to 404 and the privilege information and viewing-and-listening histories 601 to 604 are input as the viewing-and-listening information (step 204).

Subsequently, the attraction device 801 retrieves the service ID corresponding to a privilege service which can be carried out in the attraction system 101 from the service ID 601 in the viewing-and-listening information input by the information input terminal 803 (step 902). If there is no service ID, a usual operation of the attraction is continued as it is (step 910).

If there is a service ID, the attraction device 801 compares a current date with the expiration date 602 so as to check as to whether or not the expiration date 602 corresponding to the service ID 601 passes (step 903). If the service expires, the expiration is displayed on the terminal 803 installed at the entrance of the attraction site or on the terminal 803 mounted on the ride 802 (step 911), and thus, the usual operation is continued (step 910).

Before the date, the privilege information and viewing-and-listening history 601 to 604 corresponding to the service ID are deleted (step 904). Subsequently, the character in the attraction device 801 is selected in accordance with the following procedure (step 905): (1) in the case where the favorite character 404 exists in the attraction system 101, the character 404 is selected; (2) in contrast, in the case where no favorite character exists, a character is selected based on the contents ID 603, and in a normal case, a character appearing in the corresponding contents is selected.

Here, it is to be understood that in the case where the service corresponding to the service ID 601 is offered in the attraction system 101, the character appearing in the contents 505 having the service ID 502 attached thereto exists in the attraction system.

Subsequently, the attraction device 801 composes a sentence to be uttered by the character (step 906). The character selected in step 905 utters the sentence composed in step 906 (step 907), thus carrying out the privilege service. Here, the character may be allowed to wave while uttering the sentence. Moreover, such an action may be changed in accordance with the viewing-and-listening information.

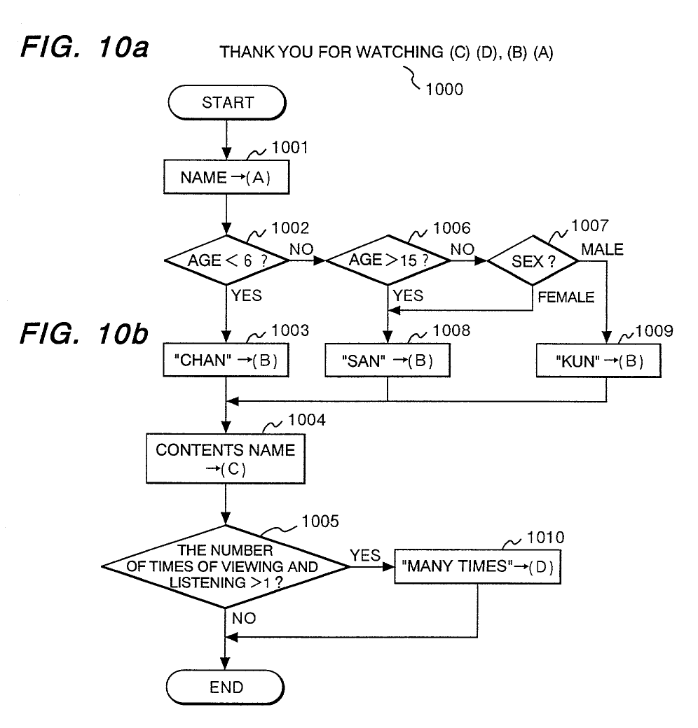

Next, a detailed example of the sentence composing processing (step 906) performed by the attraction device 801 will be explained in reference to FIGS. 10, 4 and 6. Generally, the sentence is composed by inserting words into positions (A), (B), (C) and (D) of a template 1000 of a sentence illustrated in FIG. 10A.

In the processing illustrated in FIG. 10B, the attraction device 801 first inserts the name 401 of the viewer-and-listener into the position (A) (step 1001). And then, if the age 403 is less than 6 (step 1002), a suffix “-chan” is inserted into the position (B) (step 1003); or, if the age 403 exceeds 15 (step 1006), a suffix “-san” is inserted into the position (B) (step 1008). If the age 403 ranges from 6 to 15 and the sex 402 is male (step 1007), a suffix “-kun” is inserted into the position (B) (step 1009). If the sex 402 is female (step 1007), the suffix “-san” is inserted into the position (B) (step 1008).

Thereafter, the contents name corresponding to the contents ID 603 is inserted into the position (C) (step 1004). Finally, if the number 604 of times of viewing and listening is plural (step 1005), a phrase “many times” is inserted into the position (D) (step 1010).

For example, in the case of the data illustrated in FIGS. 5 and 6, when the name of the contents 505 having the contents ID “1234” is “Metan and his friends”, the composed sentence results in “Thank you for watching Metan and his friends, Suzuki Mika-san!”In the meantime, if the age 403 is 3 and the number 604 of times of viewing and listening is “2”, the composed sentence results in “Thank you for watching Metan and his friends many times, Suzuki Mika-chan!”

There may be other various privileges by using the read personal information (FIG. 4) and the read privilege information and viewing-and-listening history (FIG. 6). Examples of such privileges will be listed below in reference to FIGS. 1, 4 to 6 and 8. Incidentally, the procedures described below will be implemented by basically replacing the processing in steps 905 to 907 illustrated in FIG. 9.

(1) When the viewer-and-listener uses the attraction system 101 or enters the theme park, he or she inserts the removable media 102 into the information input terminal 803 also having the function of an admission dispenser. The viewing-and-listening information is read in the attraction system 101 or the theme park, and then, if there is a corresponding service ID 601, an admission fee is discounted according to the number 604 of times of viewing and listening.

(2) Two entrances are installed in the attraction system 101: one of the two entrances is used as a normal entrance, while the information input terminal 803 is installed at the other entrance. Only in the case where the viewer-and-listener inserts the removable media 102 into the terminal and the service ID 601 corresponding to the attraction exists in the media, the viewer-and-listener can enter the attraction system through the other entrance. Consequently, only a visitor who views and listens to the contents 505 can preferentially enjoy the attraction. This service may be combined with a fast pass service (there has been previously issued a reference ticket valid only during a designated period of time, during which visitors can preferentially enter the attraction system through the other entrance).

(3) A plurality of routes are provided in the ride 802 in the attraction system 101. First, the viewer-and-listener inserts the removable media 102 into the information input terminal 803. In the case where the attraction system 101 reads the viewing-and-listening information and the service ID 601 corresponding to the attraction exists, the route is changed according to the favorite character 404 in the corresponding contents ID 603 or personal information. In general, the viewer-and-listener selects a route in which a story contained in the viewed-and-listened contents is developed or a route in which the favorite character appears. A surcharge may be imposed on a visitor, who does not bring the removable media 102 or has a medium in which no applicable service ID 601 is recorded, so as to offer a similar service to the visitor. In this case, the plurality of routes may be selected at random.

(4) The viewer-and-listener inserts the removable media 102 into the information input terminal 803 after the use of the ride 802. In the case where the attraction reads the viewing-and-listening information and the corresponding service ID 601 exists, the viewer-and-listener receives a present of a character doll or the like.

The above-described services as the privileges can be combined with the service in which the character calls the name of the visitor, described first.

According to the present invention, since the viewer-and-listener can receive the service of the privilege in the attraction if he or she has viewed and listened to the contents, the viewer-and-listener of the contents can be induced to the theme park.

It is to be understood that the present invention is not restricted to the particular embodiment given above, and various modifications and alterations can be added thereto without departing from the scope of the invention as encompassed by the appended claims.

What is claimed is:

1. A cooperation service method of contents viewing/listening and an attraction comprising the steps of:
recording, in a portable recording medium, viewing-and-listening information on viewing-and-listening of contents relating to an attraction;
reading the viewing-and-listening information recorded in the recording medium in an attraction system for performing the attraction; and
carrying out a privilege service of the attraction based on the read viewing-and-listening information.

2. A cooperation service method of contents viewing/listening and an attraction as claimed in claim 1, wherein the contents are broadcast through a transmission path, are received by a contents receiver, and thus, are allowed to be viewed and listened to.

3. A cooperation service method of contents viewing/listening and an attraction as claimed in claim 1, wherein the viewing-and-listening information includes at least one of a viewing-and-listening history, in which the contents viewing-and-listening is recorded, and information on the privilege service relating to the contents.

4. A cooperation service method of contents viewing/listening and an attraction as claimed in claim 3, wherein the viewing-and-listening information includes personal information on a viewer-and-listener of the contents.

5. A cooperation service method of contents viewing/listening and an attraction as claimed in claim 1, wherein the privilege service is a service in which the attraction system performs an operation different from a usual operation for a viewer-and-listener of the contents.

6. A cooperation service method of contents viewing/listening and an attraction as claimed in claim 1, wherein the privilege service is a service in which a character in the attraction system talks to a viewer-and-listener of the contents.

7. A cooperation service method of contents viewing/listening and an attraction as claimed in claim 3, wherein the viewing-and-listening history includes at least one of information specifying the viewed and listened contents and the number of times of viewing and listening.

8. A cooperation service method of contents viewing/listening and an attraction as claimed in claim 3, wherein the privilege information includes at least one of information specifying the privilege service, an expiration date of the privilege service, information specifying the contents relating to the privilege, and a message relating to the privilege.

9. A cooperation service method of contents viewing/listening and an attraction as claimed in claim 4, wherein the personal information includes at least one of the name, sex, age and favorite character of the viewer-and-listener.

10. A portable recording medium for use in the cooperation service method of the contents viewing/listening and the attraction as claimed in claim 1, the portable recording medium having viewing-and-listening information on viewing-and-listening of contents relating to an attraction recorded therein.

11. A contents receiver comprising:
a receiving device for receiving contents relating to an attraction, the contents being broadcast through a transmission path;
an output device for outputting the received contents in such a manner as to allow them to be viewed and listened to; and
a recording device for recording viewing-and-listening information on viewing-and-listening of the contents in a portable recording medium.

12. An attraction system comprising:
an attraction device for performing an attraction; and
information input equipment for inputting viewing-and-listening information from a recording medium having the viewing-and-listening information on viewing-and-listening of contents relating to the attraction recorded therein;
wherein a privilege service is carried out based on the viewing-and-listening information input by the information input equipment.

13. An attraction system as claimed in claim 12, wherein the viewing-and-listening information includes at least one of a viewing-and-listening history in which the contents viewing-and-listening is recorded and privilege information on the privilege service relating to the contents.
